(19) United States
(12) Patent Application Publication
(10) Pub. No.: US 2026/0064242 A1
(43) Pub. Date: Mar. 5, 2026

(54) ENHANCED HOME SCREEN ICON SEARCH AND NAVIGATION

(71) Applicant: Mark Lambert, Tarpon Springs, FL (US)

(72) Inventor: Mark Lambert, Tarpon Springs, FL (US)

(21) Appl. No.: 18/818,473

(22) Filed: Aug. 28, 2024

(51) Int. Cl. G06F 3/0482; G06F 3/04817; G06F 3/0483; G06F 3/16; G06F 9/451; H04M 1/72403; H04M 1/72472

(52) U.S. Cl. CPC G06F 3/0482; G06F 3/04817; G06F 3/0483; G06F 3/167; G06F 9/451; H04M 1/72403; H04M 1/72472

(57) ABSTRACT

The disclosed technology relates to searching for the spatial location of an icon on a home screen that includes multiple icons linked to apps or widgets. The home screen can include a search field for user input to locate a specific app or widget. Upon receiving a search query, the system identifies and visually indicates the spatial location of the corresponding icon on the home screen. The visual indication can include displaying a path, displaying navigable instructions, highlighting the icon or folder, or making the icon oscillate. The system also corrects misspellings in the search query and maintains the visibility of icons while using the search field.

### BACKGROUND

Smartphones and other smart devices have become ubiquitous, serving as essential tools for communication, entertainment, productivity, and more. A key feature of these devices is their user interface, which allows users to interact with the device's various functions and applications. The home screen is a central component of this user interface, providing users with quick access to their most frequently used apps and information.

The home screen typically displays a grid or list of icons, each representing a different app installed on the device. These icons are graphical representations that users can tap to launch the corresponding app. The arrangement and appearance of these icons can often be customized by the user, allowing for a personalized user experience. In addition to app icons, the home screen may also feature widgets, which are small, interactive elements that provide quick access to information or functions without needing to open a full app. Examples of widgets include weather forecasts, calendar events, and music controls.

The design and functionality of the home screen are critical to the overall user experience of a smartphone. Innovations in this area can significantly enhance the usability and appeal of the device, making it more intuitive and efficient for users to navigate and access their desired applications and information.

### BRIEF DESCRIPTION OF THE DRAWINGS

Detailed descriptions of implementations of the present invention will be described and explained through the use of the accompanying drawings.

FIG. 1A illustrates a home screen on a user device (e.g., smartphone) including a search field configured to search for apps or widgets with shortcuts on the home screen.

FIG. 1B illustrates a home screen on a smartphone that highlights an icon linked to an app or widget and includes an arrow that points to the icon that matches a search query input to a search field on the home screen.

FIG. 1C illustrates a home screen on a smartphone that oscillates an icon linked to an app or widget that matches a search query input to a search field on the home screen.

FIG. 1D illustrates a home screen on a smartphone that highlights a folder icon including an icon linked to an app or widget that matches a search query input to a search field on the home screen.

FIG. 1E illustrates a home screen on a smartphone that highlights a page of a home screen that includes an icon linked to an app or widget that matches a search query input to a search field on the home screen.

FIG. 2 is a flowchart of a process for searching for a particular app widget located on a home screen of a user device.

FIG. 3 is a block diagram that illustrates an example of a computer system in which at least some operations described herein can be implemented.

FIG. 4 illustrates an embodiment of a user engaged with an email application through a mixed reality system.

FIG. 5 is a block diagram of an embodiment illustrating stacks of a mixed reality platform that can administer a session on a near-to-eye display system.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides methods and systems for improved application management and searching on a user device (e.g., smartphone). An aspect of the technology enables a user to input a search query in a search field to locate a mobile application (“mobile app”). The user device can present the search results by visually identifying the location of the searched apps that match the keywords in the query. In this way, users can learn the location of the application thereby eliminating the need to use the search field later to locate the same application.

This feature significantly enhances user experience by reducing the time and effort required to find and open applications. Instead of repeatedly typing the same search queries, users can quickly navigate to the desired app based on their memory of its location, which is visually reinforced by the search results. Additionally, this method can help in decluttering the home screen by allowing users to rely on the search function for less frequently used apps, rather than keeping all apps readily accessible on the home screen. Moreover, the technology can be integrated with voice search capabilities, enabling users to find applications through voice commands, which is particularly useful for users with disabilities or those who prefer hands-free operation. The system can also learn from the user's search habits and frequently accessed applications to provide personalized search suggestions, making the process even more efficient over time. Furthermore, the search results can be displayed in various formats, such as a list or grid view, and can include additional information about the applications, such as usage frequency, last accessed time, and user ratings, to help users make informed decisions about which app to open.

A home screen is the main screen on a device or computer program. Home screens are not identical because users rearrange icons as they please, and home screens often differ across mobile operating systems. Home screens usually consist of a grid of application links that can often be arranged over multiple pages and serve as the user's main method of accessing phone functions. Most operating systems allow users to add folders to the home screen in order to further organize application links. These folders can be named and customized according to the user's preferences, providing an additional layer of organization. For instance, a user might create folders for different categories of apps such as “Work,” “Entertainment,” “Utilities,” and “Social Media.” This organizational capability is crucial for users who have a large number of applications installed on their devices as it helps them to quickly find and access the apps they need. Furthermore, some home screens offer widgets, which are small applications that provide at-a-glance information or quick access to certain functions without opening the full app. This can include weather updates, calendar events, or music controls, further enhancing the functionality and convenience of the home screen. In addition to folders and widgets, home screens can also feature shortcuts to specific functions within an app, such as a direct link to the camera mode in a photo app or a new message composition screen in a messaging app. This allows users to perform common tasks more quickly and efficiently. The layout and design of the home screen can often be customized with different themes, wallpapers, and icon styles, allowing users to personalize their device to reflect their individual tastes and preferences. Some advanced home screen setups even support dynamic content, such as live wallpapers that change based on the time of day or user activity, adding an extra layer of interactivity and engagement.

A search box, search field, or search bar is a graphical control element used in computer programs, such as file managers or web browsers, and on web sites. A search box is usually a single-line text box or search icon with the dedicated function of accepting user input to be searched for in a database. Depending on the particular implementation, a search box may be accompanied by a drop-down list to present the user with past searches or search suggestions. Search boxes may have other features to help the user, such as autocomplete, search suggestions, a spelling checker, etc. These features are designed to make the search process more efficient and user friendly. For example, autocomplete can predict the rest of a search query based on the initial characters typed by the user, saving time and reducing the likelihood of errors. Search suggestions can provide alternative queries that might yield better results, while a spelling checker can correct typos or misspellings in the search input. Search boxes are often also accompanied by drop-down menus or other input controls to allow the user to restrict the search or choose what type of content to search for.

In some cases, while users input search strings, the results of that string would also present on the content area updating in real time. This real-time updating feature, often referred to as “live search” or “instant search,” allows users to see the results of their query as they type, providing immediate feedback and helping them to refine their search terms on the fly. This can be particularly useful in applications where users need to quickly find specific information or items, such as in large databases or e-commerce sites. Additionally, search boxes can be integrated with voice recognition technology, allowing users to perform searches using voice commands, which can be particularly useful in hands-free scenarios or for users with disabilities. Advanced search boxes may also support natural language processing, enabling users to input queries in a more conversational manner and receive more accurate and relevant results. Furthermore, search boxes can be designed to handle complex queries involving multiple criteria, such as date ranges, file types, or specific metadata, providing users with powerful tools to narrow down their search results and find exactly what they are looking for.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Locating Icons for Apps or Widgets on a Home Screen

The present technology relates to a non-transitory, computer-readable storage medium that stores instructions executable by at least one data processor of a device such as a smartphone, tablet computer, or any device having a home screen that includes icons for apps or widgets. These instructions enable the device to perform a series of operations that enhance the user experience by providing an intuitive and efficient way to navigate and access apps or widgets on the home screen.

The technology causes display of a home screen on the smartphone's display. This home screen includes multiple icons, each representing a link (e.g., shortcut) to a respective app or widget accessible on the smartphone. The icons are placed at non-overlapping locations on each page of the home screen, ensuring a clutter-free and organized interface. For example, a user might have icons for messaging, email, and social media apps on the first page, while productivity tools and games are on subsequent pages.

The home screen can include a control such as a search field. This search field allows users to input search queries indicative of an app or widget they wish to access. In an embodiment, the search field can search for information about apps or widgets without identing a spatial location of a corresponding icon. A user input can be received to switch the search field to operate in another mode configured to find and present an indication of the spatial location of an icon on the home screen. As such, upon receiving an input including the search query, the smartphone identifies the particular app or widget that satisfies the search query. If set in the mode to search for spatial locations, the result of the search query includes the corresponding icon and its specific location on the home screen. For instance, if a user types “calendar” into the search field, the smartphone will identify the calendar app and its icon on the home screen.

To assist users in quickly finding the desired app or widget, the technology causes the display of a visual indication of the particular icon's location on the home screen. This visual indication can take various forms, such as highlighting the icon, displaying a path to the icon, or providing navigational instructions. For example, the icon might be highlighted with a glowing border, or an arrow might appear pointing to its location.

In one embodiment, the visual indication includes displaying a path to the particular icon's location on the home screen. This path guides the user from their current location on the home screen to the icon's location, making it easy to find the desired app or widget. For instance, a dotted line might appear, leading the user from their current position to the icon.

In another embodiment, the visual indication involves displaying instructions for navigating from the current page of the home screen to the page where the particular icon is located. In another embodiment, the visual indication involves automatically switching display to a page, other than the current page, including the icon. If the icon is inside a folder, the instructions will guide the user to the specific folder and highlight the icon within it. For example, the instructions might read, “Swipe left to page 3, then open the ‘Utilities’ folder.”

The technology also includes a feature that highlights a folder on the home screen in which the particular icon is located. This highlighted version may involve a change in the size or font of the icon relative to other icons on the home screen or a movement of the icon to draw the user's attention. For instance, the folder might enlarge slightly or change color to indicate it contains the desired icon.

To enhance the accuracy of search results, the technology includes a disambiguation feature. This feature corrects misspellings or typographical errors in the search query, ensuring that the best matching app or widget is identified. For example, if a user types “calendr” instead of “calendar,” the smartphone will still identify the calendar app.

The technology also matches a combination of characters in the search query with the name of the particular app or widget. This matching process ensures that even partial or incomplete queries can yield accurate results. For instance, typing “cal” might bring up both “calendar” and “calculator” apps.

The search field can be overlaid on the home screen, allowing users to input their search queries without losing sight of the multiple icons displayed on the home screen. This simultaneous viewability ensures a seamless and efficient search experience. For example, the search field might appear as a translucent overlay at the top of the screen.

In some embodiments, the smartphone automatically navigates from the current view of the home screen to the particular location of the icon. This automatic navigation saves time and effort for the user, providing a direct route to the desired app or widget. For instance, the screen might automatically switch to the page containing the icon.

The visual indication of the icon's location can also involve highlighting a particular page of the home screen that contains the icon. This highlighted page stands out from the current page, guiding the user to the correct location. For example, the page might be highlighted with a different background color or a border.

Additionally, the technology can highlight a folder icon that contains a subset of multiple icons, including the particular icon. This highlighting helps users quickly identify the folder where the desired app or widget is stored. For instance, the folder might pulse or glow to draw attention.

To further draw attention to the particular icon, the technology can cause the home screen to display the icon prominently relative to all other icons on the current page. This prominence can be achieved through visual effects such as size increase, color change, or animation. For example, the icon might enlarge and change color to stand out.

In some cases, the particular icon or the folder icon containing it may visually oscillate on the home screen. This oscillation creates a dynamic visual effect that captures the user's attention and directs them to the desired app or widget. For instance, the icon might gently move back and forth or pulse.

The technology also encompasses a method for displaying multiple icons for respective apps or widgets on a home screen. These icons are visual elements with spatial locations on the home screen, configurable by the user. Each icon is linked to a particular app or widget stored on the user device. For example, users can drag and drop icons to arrange them according to their preferences.

In an example of a method, a device receives user input that includes a search query for a specific app or widget. The search query result matches the app or widget and maps the result to the corresponding icon. The method then causes the display of a visual indication that maps to the spatial location of the icon on the home screen. For instance, typing “music” might highlight the music app icon.

Prior to displaying the visual indication, the method matches a combination of characters in the search query to the name or metadata of the app or widget. This matching process accounts for misspellings and typographical errors, ensuring accurate search results. For example, typing “musci” instead of “music” will still yield the correct app.

The method also involves displaying a search field overlaid on one or more icons on the home screen. Users can input their search queries into this field while maintaining simultaneous viewability of the icons on the home screen. For instance, the search field might appear as a semi-transparent overlay.

The visual indication may include navigable instructions from the current view of the home screen to the spatial location of the icon. If the icon is on a different page or inside a folder, the instructions will guide the user accordingly. For example, the instructions might read, “Swipe right to page 2, then open the ‘Games’ folder.”

To make the icon stand out, the method can cause the home screen to display the icon prominently relative to other icons on the current page. This prominence helps users quickly locate the desired app or widget. For example, the icon might be highlighted with a bright color or animation.

The visual indication can also involve highlighting a page of the home screen that contains the icon. This highlighted page stands out from the current page, guiding the user to the correct location. Additionally, the method can highlight a folder that contains a subset of multiple icons, including the desired icon. For instance, the folder might be highlighted with a different color or animation.

Overall, the technology provides a comprehensive solution for efficiently navigating and accessing apps or widgets on a smartphone's home screen. By incorporating features such as search fields, visual indications, and disambiguation, the technology enhances the user experience and simplifies the process of finding and launching apps or widgets.

Alternative implementations of the technology could include voice-activated search functionality, where users can speak their search queries instead of typing them. This would involve integrating voice recognition technology to interpret and process spoken commands. For example, a user could say “Open calendar” to locate and launch the calendar app.

Another alternative implementation could involve gesture-based navigation, where users can perform specific gestures to search for and locate apps or widgets. For instance, a user might swipe in a particular pattern to initiate a search or navigate to a specific page on the home screen.

Additionally, the technology could be adapted for use on other types of devices, such as tablets, smartwatches, or smart TVs. The principles of the technology would remain the same, but the user interface and interaction methods might be tailored to suit the specific device. For example, on a smartwatch, the search field might be activated by a long press on the screen, and the visual indications might involve haptic feedback in addition to visual cues.

In summary, the technology offers a versatile and user-friendly solution for managing and accessing apps or widgets on a smartphone's home screen. By providing multiple methods for locating and highlighting icons, the technology ensures that users can quickly and easily find the apps or widgets they need, enhancing the overall user experience.

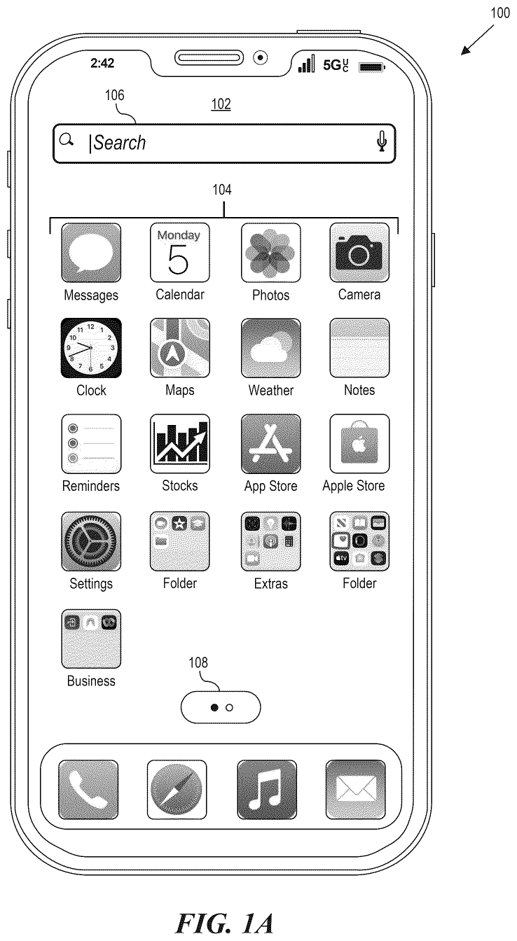

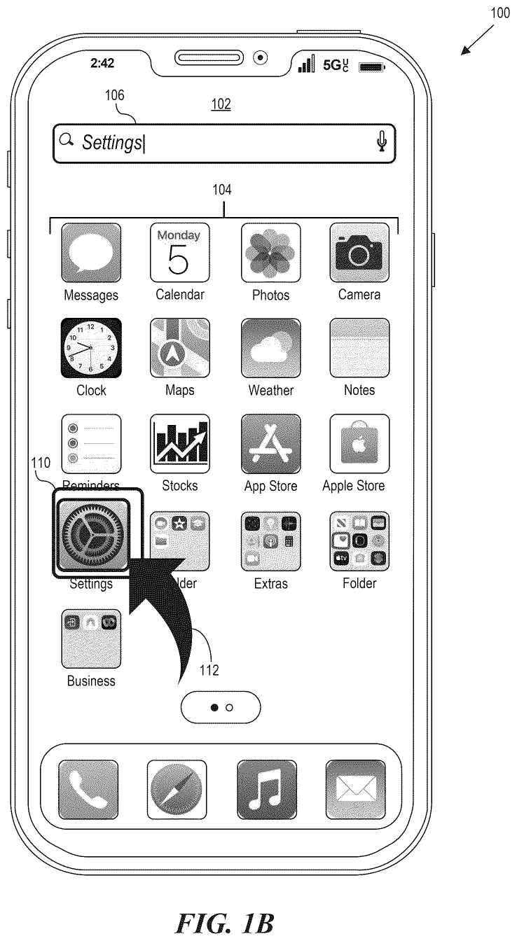

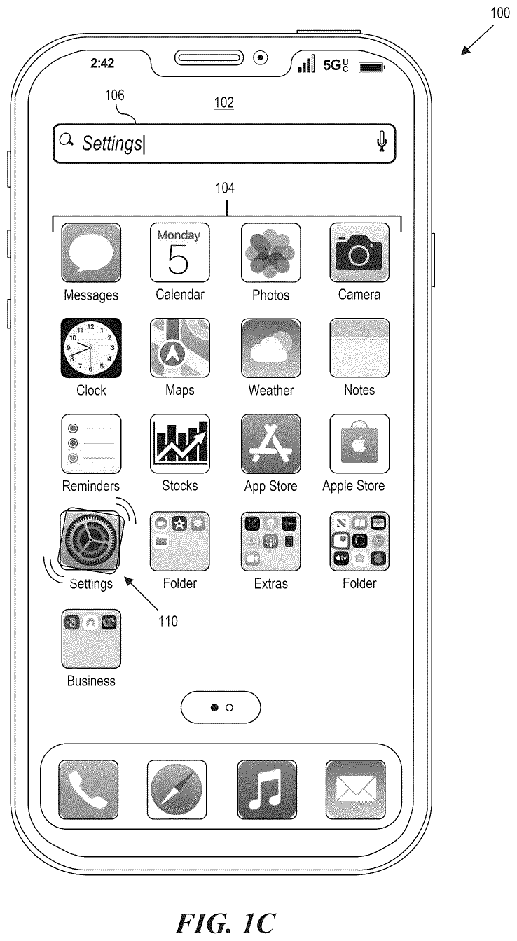

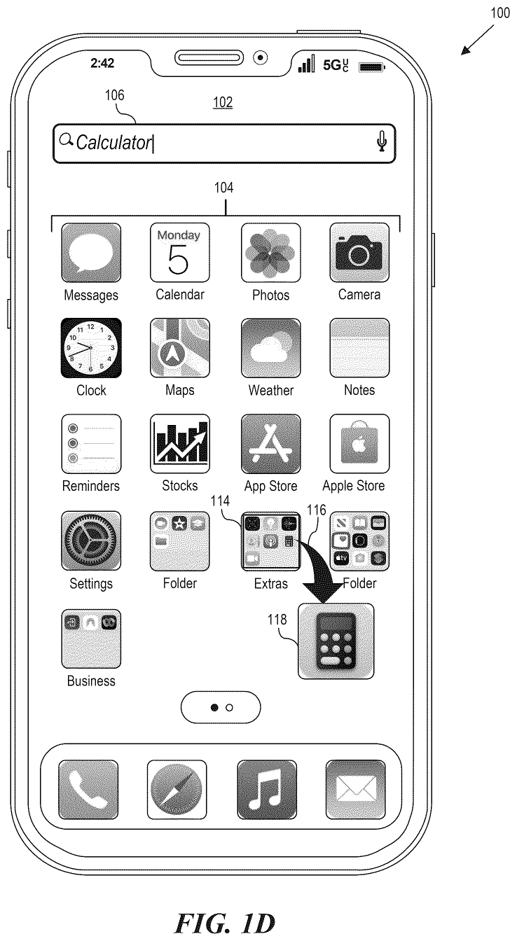

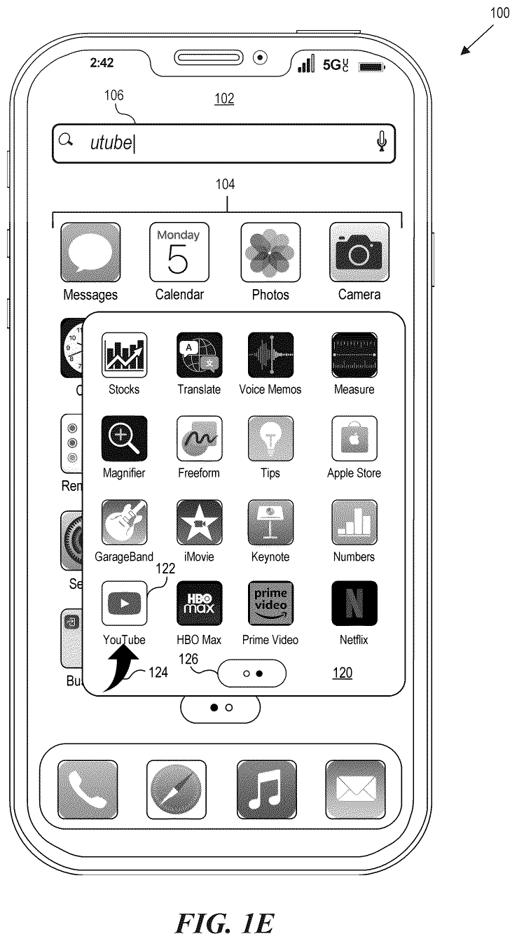

FIG. 1A depicts a home screen interface on a user device, such as a smartphone 100. The home screen 102 features a grid layout with multiple icons 104, each representing a shortcut to an app or widget installed on the device. Displayed at the top of the home screen 102 is a search field 106, designed to allow users to input search queries to locate specific apps or widgets. The search field 106 is integrated seamlessly into the home screen 102, enabling users to perform searches without losing sight of the icons. This setup enhances user experience by providing an intuitive and efficient method for navigating and accessing various applications directly from the home screen 102. In the illustrated example, the home screen 102 includes at least two pages with different sets of icons. A control 108 shows the current page indicated by a filled circle and a second page with an unfilled circle, which the user can navigate to by swiping to navigate to the right.

FIG. 1B shows a home screen 102 interface on a smartphone 100, emphasizing the functionality of locating an app or widget based on a search query. The home screen 102 displays a grid of icons 104, each representing a shortcut to an app or widget. At the top of the screen, a search field 106 is visible, where users can input their search queries. In response to a search query “Settings,” the figure highlights a specific Settings icon 110 that matches the search term “Settings.” An arrow 112 is also shown pointing directly to the highlighted icon 110, providing a clear visual indication of its location on the home screen 102. The icon 110 is emphasized with an animation to increase in size compared to other icons and on the current view of the home screen 102. This visual aid helps users quickly and easily find the desired app or widget, enhancing the overall user experience.

FIG. 1C presents the home screen 102 interface on the smartphone 100, demonstrating the dynamic visual effect used to locate an app or widget based on a search query. The home screen 102 features the grid of icons 104, each serving as a shortcut to an app or widget installed on the device. At the top of the screen, a search field 106 is prominently displayed, allowing users to input search queries to find specific applications or widgets. This search field 106 is seamlessly integrated into the home screen 102, ensuring that users can perform searches without losing sight of the icons. The layout is designed to be intuitive and user friendly, providing a streamlined method for navigating the device's applications.

Upon entering a search query “Settings,” FIG. 1C highlights a Settings icon 110 that matches the search terms “Settings” by causing it to oscillate. This oscillation effect involves the icon gently moving back and forth, creating a dynamic visual cue that draws the user's attention to the icon 110, which is a shortcut for the Settings app. The oscillation makes it easier for users to quickly locate the desired application, enhancing the overall user experience. This feature is particularly useful in reducing the time and effort required to find and open apps, making the home screen 102 more efficient and engaging. The combination of the search field 106 and the oscillating icon 110 provides a powerful tool for users to manage and access their applications or widgets with ease.

FIG. 1D illustrates the home screen 102 on a smartphone 100, showcasing the functionality of locating an app or widget within a folder based on a search query. The home screen features a grid of icons 104, each representing a shortcut to an app, widget, or folder containing multiple icons for multiple apps or widgets. At the top of the screen, a search field 106 is displayed, allowing users to input search queries to find icons for specific apps or widgets. This search field 106 is seamlessly integrated into the home screen 102, ensuring that users can perform searches without losing sight of the icons and folders.

In the illustrated example, upon entering a search query (e.g., “Calculator”), FIG. 1D highlights a folder icon 114 that contains the icon 118 to the calculator app matching the search term “Calculator.” The highlighted folder icon 114 stands out from the other icons on the home screen, making it easily identifiable. This visual indication (e.g., double frame) helps users quickly locate the folder icon 114 where the desired icon 118 for the app is stored. In the illustrated example, an arrow is displayed as an additional visual indication of the location of the desired icon 118. By providing a clear and efficient method for finding applications within folders, this feature enhances the overall user experience, reducing the time and effort required to navigate through multiple folders and locate specific apps or widgets. Moreover, by learning the location of the icon for an app or widget, the user can better manage the locations of icons and learn the locations.

FIG. 1E illustrates the home screen 102 on the smartphone 100, demonstrating the functionality of locating icons for apps or widgets based on search queries by highlighting the specific page of the home screen where an icon is located. The home screen 102 is organized into multiple pages, each displaying a grid of icons representing shortcuts to various apps and widgets. At the top of the current page, a search field 106 is displayed, allowing users to input search queries to find icons for specific apps or widgets. This search field 106 is seamlessly integrated into the home screen 102, ensuring that users can perform searches without losing sight of the icons and pages.

Upon entering a search query (e.g., “utube”), FIG. 1E highlights the specific page 120 of the home screen 102 that contains the icon 122 matching the search terms “utube.” This highlighted page 120 stands out from the other pages, providing a clear visual indication of where the desired icon 122 is located. The display includes visual cue 124 such as an arrow pointing to the location of the icon 122 on the second page 120. The display includes the control 126 indicating that the page 120 is the second page 120 of the home screen 102. That is, the rightmost circle of the control 126 is filled instead of the leftmost circle. Other techniques of highlighting the location of an icon can involve a different background color, border, or other distinguishing features to make a page or an icon easily identifiable. This feature helps users quickly navigate to the correct page, folder on the page, and icon inside the folder to significantly enhance the overall user experience by reducing the time and effort required to find and open applications on the home screen.

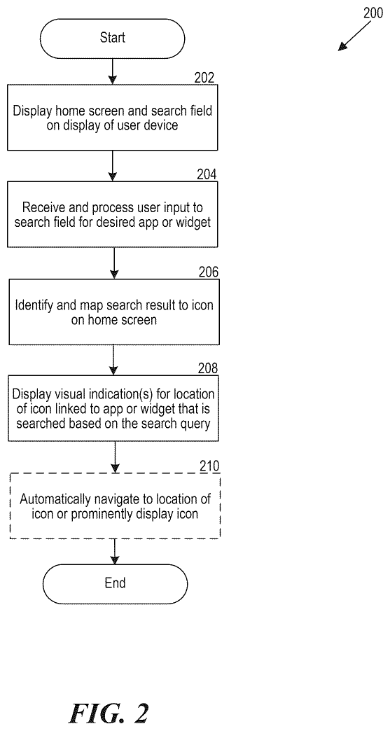

FIG. 2 is a flowchart of a method 200 for searching for a particular app widget located on a home screen of a user device. The process can be performed by a user device on which the home screen is displayed or remote from the user device such as a server connected to the user device. As such, the method 200 can be described in the context of a system (including a user device, server, etc.) storing instructions that, when executed by at least one processor of the system, can perform the method 200. To aid in ease of understanding, the method is described using a smartphone.

At 202, the smartphone displays a home screen and a search field on the smartphone's display. This home screen features multiple icons, each representing a link (e.g., shortcut) to a respective app or widget accessible on the smartphone. The icons are strategically placed at non-overlapping locations on one or more pages of the home screen, ensuring a clutter-free and organized interface. Additionally, the search field is displayed on the home screen, allowing users to input search queries directly from the main interface. This search field is overlaid on the home screen, maintaining the simultaneous viewability of the multiple icons, thus providing a seamless user experience.

At 204, the smartphone receives and processes user input upon displaying the home screen and search field. The method 200 proceeds to receive the user input in the form of a search query. This query is indicative of an app or widget that the user wishes to access. The smartphone processes this input by matching the combination of characters in the search query with the names or metadata of the apps or widgets stored on the device. The method includes a disambiguation process to correct any misspellings or typographical errors in the search query, ensuring that the best match for the intended app or widget is identified.

At 206, the smartphone identifies and maps the search result to an icon on the home screen once the search query is processed. The method 200 identifies the particular app or widget that satisfies the search query. The smartphone then maps this result to a specific icon linked to the identified app or widget. The method also determines the spatial location of this icon on the home screen, which includes the particular page and folder where the icon is stored. This mapping process is useful for the subsequent steps, as it allows the smartphone to provide precise visual indications to the user.

At 208, the smartphone displays visual indications for the location of the icon linked to the app or widget that is searched based on the search query. That is, the smartphone causes the display of a visual indication that maps to the spatial location of the identified icon on the home screen. This visual indication can take various forms, such as highlighting the particular page or folder containing the icon, displaying a path to the icon's location, or causing the icon or its folder to visually oscillate. Additionally, the smartphone can display navigable instructions to guide the user from the current page to the page where the icon is located, particularly if the icon is inside a folder on a different page. These visual cues ensure that the user can easily locate the desired app or widget.

At 210, the smartphone can optionally automatically navigate to a location of the icon or prominently display the icon. That is, an automatic navigation feature allows the smartphone to navigate from the current view of the home screen to the particular location of the identified icon. This automatic navigation ensures that the user is directed to the exact location of the icon for the app or widget without manual intervention. Furthermore, the method can cause the home screen to display the identified icon prominently relative to other icons on the current page, making it easier for the user to recognize and access the desired app or widget. This step enhances the overall user experience by providing a quick and efficient way to locate and launch apps or widgets on the smartphone.

In another example, the user device captures a verbal command as input from the user to the user device. The verbal command includes a search query for an app or widget stored at the user device. The result of the search query includes an audio indication of the location of the second app or widget and maps on the home screen. For example, the user can ask an electronic assistant to show the location of a calendar app. The electronic assistant can then respond with a description of the location of the icon on the home screen (e.g., “at the lower right of the home screen).

### Computer System

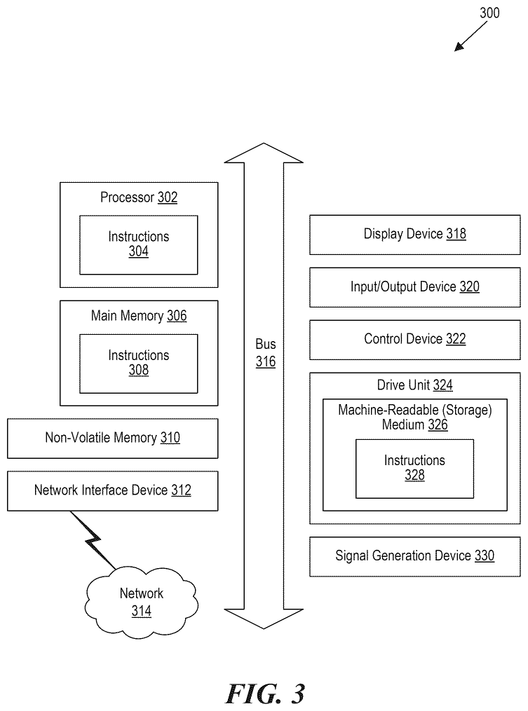

FIG. 3 is a block diagram that illustrates an example of a computer system 300 in which at least some operations described herein can be implemented. As shown, the computer system 300 can include: one or more processors 302, main memory 306, non-volatile memory 310, a network interface device 312, a video display device 318, an input/output device 320, a control device 322 (e.g., keyboard and pointing device), a drive unit 324 that includes a machine-readable (storage) medium 326, and a signal generation device 330 that are communicatively connected to a bus 316. The bus 316 represents one or more physical buses and/or point-to-point connections that are connected by appropriate bridges, adapters, or controllers. Various common components (e.g., cache memory) are omitted from FIG. 3 for brevity. Instead, the computer system 300 is intended to illustrate a hardware device on which components illustrated or described relative to the examples of the figures and any other components described in this specification can be implemented.

The computer system 300 can take any suitable physical form. For example, the computing system 300 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 300. In some implementations, the computer system 300 can be an embedded computer system, a system-on-chip (SOC), a single-board computer system (SBC), or a distributed system such as a mesh of computer systems, or it can include one or more cloud components in one or more networks. Where appropriate, one or more computer systems 300 can perform operations in real time, in near real time, or in batch mode.

The network interface device 312 enables the computing system 300 to mediate data in a network 314 with an entity that is external to the computing system 300 through any communication protocol supported by the computing system 300 and the external entity. Examples of the network interface device 312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 306, non-volatile memory 310, machine-readable medium 326) can be local, remote, or distributed. Although shown as a single medium, the machine-readable medium 326 can include multiple media (e.g., a centralized/distributed database and/or associated caches and servers) that store one or more sets of instructions 328. The machine-readable medium 326 can include any medium that is capable of storing, encoding, or carrying a set of instructions for execution by the computing system 300. The machine-readable medium 326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 304, 308, 328) set at various times in various memory and storage devices in computing device(s). When read and executed by the processor 302, the instruction(s) cause the computing system 300 to perform operations to execute elements involving the various aspects of the disclosure.

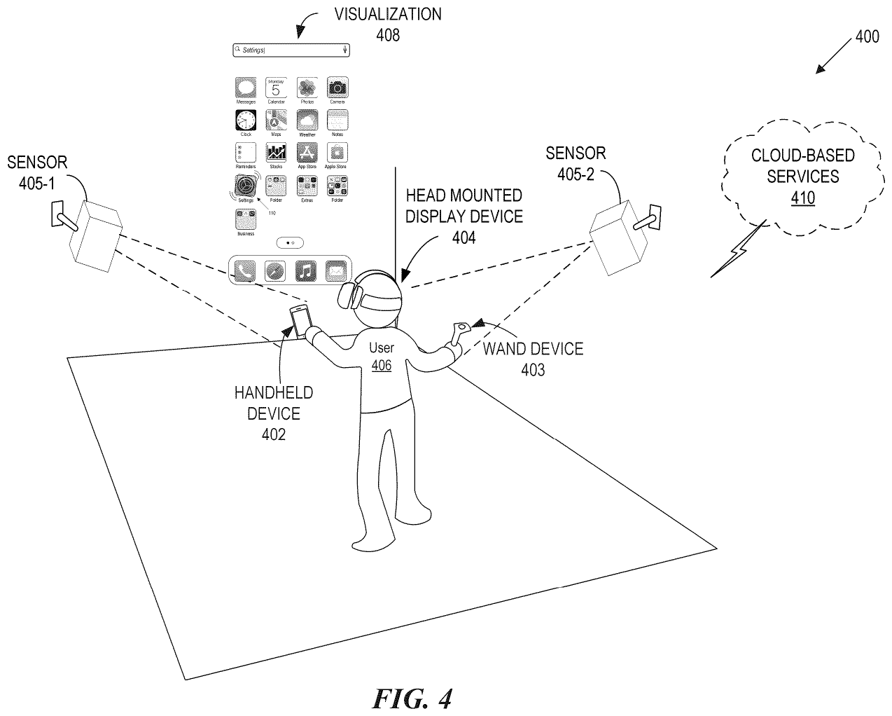

FIG. 4 illustrates a user engaged with a mixed reality system 400 for immersive message management. The components of the system 400 can include a handheld device 402 that administers a session running on other components of the system 400 including a head-mounted display (HMD) device 404 that renders a partial or full 360-degree interface. The system 400 can also include motion or position sensors 405-1 and 405-2, which are fixed in a room or worn by the user 406 such as, for example, sensors of wearables.

A near-eye display device, commonly referred to as an HMD device is an optical apparatus designed to present visual information directly in front of the user's eyes. This technology is composed of several integral components that work in unison to deliver a seamless and immersive visual experience.

Central to the near-eye display device lies the optical module. The optical module includes lenses and other optical elements that project images from a microdisplay or similar image source directly into the user's eyes. The optical module is engineered to ensure that the images are clear, focused, and appear at a comfortable viewing distance, thereby enhancing the overall user experience.

The microdisplay is a small yet high-resolution display panel responsible for generating the visual content. Utilizing technologies such as Liquid Crystal Display (LCD), Organic Light Emitting Diode (OLED), Liquid Crystal on Silicon (LCoS), or Digital Light Processing (DLP), the microdisplay renders the images or video content that the user perceives.

Supporting these components is the frame and housing, which provides the structural integrity needed to hold the optical module and microdisplay in place. Designed to be lightweight and comfortable for extended wear, the frame often includes adjustable straps or other mechanisms to ensure a secure and personalized fit on the user's head.

Modern near-eye display devices are equipped with an array of sensors, including accelerometers, gyroscopes, magnetometers, and eye-tracking sensors. These sensors enable head tracking, motion detection, and gaze tracking, significantly enhancing the interactivity and immersive nature of the device. The data collected by these sensors is processed by a built-in or connected processing unit, which handles the computation required for rendering images, processing sensor data, and managing user inputs. This processing unit may be integrated into the device or connected via a wired or wireless link to an external computer or mobile device.

Connectivity interfaces such as USB, HDMI, Bluetooth, or Wi-Fi are also integral to the device, allowing it to interface with external devices, transfer data, or receive content. The power supply, typically a battery or power management system, provides the necessary energy to operate the device efficiently, supporting extended usage without frequent recharging.

User interaction with the near-eye display device is facilitated through various user interface options, including physical buttons, touchpads, voice control, or gesture recognition systems. Additionally, some devices feature integrated speakers or headphone jacks to provide audio output, further enhancing the multimedia experience.

As illustrated, the handheld device 402 operates as a wand to navigate objects of the visualization 408 experienced by the user 406 through the HMD device 404. A dedicated wand device 403 (e.g., with one or more dedicated hardware buttons) can additionally or alternatively be used for navigation. In another example, the sensors 405-1 and 405-2 can detect the position and/or movement of the user 406's finger in the air to perform the functions including the examples illustrated in FIGS. 1A through 1E, which could be rendered in a mixed reality session like on the handheld device 402.

In some embodiments, some components of the system 400 are remotely located from the user. For example, cloud components can provide cloud-based services 410 to administer the mixed-reality session running on the components of the system 400 or provide services or content for a mixed reality session. Hence, administration of a mixed reality session could be through the HMD device 404, augmented with the handheld device 402, and/or with the cloud system 410 that receives session progress feedback (e.g., anywhere outside of room where the user is experiencing a simulation).

As shown, the HMD device 404 can provide content (e.g., visualization 408) of a mixed-reality session and process feedback from the user via the handheld device 402 to navigate the visualization 408. As shown, the HMD device 404 is a near-to-eye display system that is worn by the user 406. For example, the HMD device 404 can have a chassis and various electrical and optical components to enable an immersive experience by the user 406 wearing the HMD device 404. For example, the HMD device 404 can include a display for each of the user's eyes. The displays can render a real-world scene of a simulation for view by the user's eyes when the HMD device 404 is worn by the user. The HMD device 404 can also include a camera mounted to the chassis. The camera can capture movement of the user's pupils for physiological feedback responsive to simulated scenes being rendered. The HMD device 404 may also include a network interface enabling the handheld device 402 to communicatively couple to the HMD device 404 over a wireless connection.

In some embodiments, the HMD device 404 includes features for measuring the user's physiological activity. For example, the HMD device 404 can include components to measure the user's electrical brain activity. As such, the HMD device 404 can collect physiological data in combination with any direct input by the user. In some embodiments, the physiological data can be used to supplement the user's conscious inputs. In some embodiments, the physiological data could be used to compare against the user's conscious input.

In one example, the HMD device 404 can render a virtual immersive environment by displaying images in view of the user's eyes such that the user can only see the images (e.g., visualization 408) and see nothing of the real-world. The HMD device 404 can also render an AR environment. As such, the user can see the visualization 408 overlying on the real world while the HMD device 404 is worn by the user 406. Hence, to achieve an AR environment, the user in an augmented reality simulation has a transparent view with digital objects overlaid or superimposed on the user's real-world view.

Examples of the sensors 405-1 and 405-2 include cameras or motion detectors that are positioned proximate to the user such that the sensors 405-1 and 405-2 can obtain real-world feedback responsive to interactions with a simulated real-world scene. For example, cameras facing the user can detect the user 406's movement while the user is engaged in a simulation and provide feedback to the HMD device 404 administering the simulation. The handheld device 402 can be used by the user 406 to submit input, which can include actuating buttons for the user 406 to input data and/or accelerometers that detect spatial movement. For example, the user 406 can move the handheld device 402 to provide inputs responsive to a scene administered by the HMD device 404.

The visualization 408 is one example of many that can be rendered in a mixed-reality session. FIGS. 1A through 1E show examples of visualizations that could likewise be rendered in a mixed reality session. The user 406 can select and move objects of the visualization 408 in a manner described with respect to FIGS. 1A through 1E. As described further below, the system 400 can include servers that are remotely located from the user 406 and can access a program administered by the HMD device 404. Further, a local software generation and distribution framework can be used to rapidly scale content. The core components and services can support complex user and session elements that can be easily managed by a service provider. As such, a platform of a mixed reality system can standardize interaction elements such as a session landing, sign-in, navigation rules, and the like. A top-level abstraction layer can support customization such as a sequence of sessions or scenes or conditional ordering of sessions or scenes. Services can include authentication, tracking, reports, user services, help services, pause and resume services, and the like.

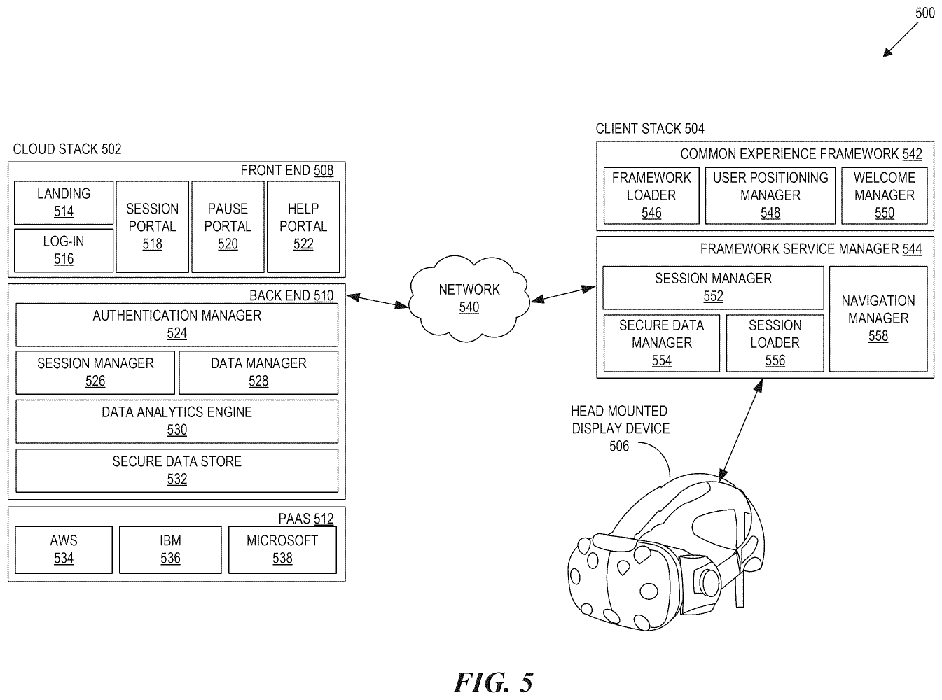

FIG. 5 is a block diagram illustrating a cloud stack 502 and a client stack 504 architecture for a platform 500 that can collectively administer a mixed reality session on an HMD device 506. As shown, the cloud stack 502 includes three primary layers: a frontend layer 508, a back-end layer 510, and a platform as a service (PaaS) layer 512. The frontend layer 508 includes a landing component 514 and a log-in component 516. The two components 514 and 516 are executed at the beginning of a session administered to orient a user and seek login credentials to control access to message programs and user information of the platform 500. The frontend layer 508 also includes a session portal 518, pause portal 520, and help portal 522. The session portal 518 is for normal front-facing operations of a simulation session whereas the pause portal 520 is for operations while the session is paused. Lastly, the help portal 522 can help the user or administrator to address questions related to the platform 500 or simulation.

The back-end layer 510 includes an authentication manager 524 that can authenticate a user and/or an administrator of the platform 500. A session manager 526 can manage access to a particular session. A data manager 528 can manage user data and/or data about the session such as any feedback from users while engaged in sessions. For example, the data manager 528 can collect feedback data from multiple users including their inputs and physiological data. A data analytics engine 530 can process the collected data to determine the actions of users and to learn how to improve the sessions (e.g., mixed reality scenes). A secure data store 532 can store sensitive data such as data that identifies users. Lastly, the PaaS layer 512 includes cloud computing services that provide the platform 500 for clients to administer the mixed reality sessions. Examples include AMAZON WEB SERVICES (AWS) 534, or services provided by IBM 536 and/or MICROSOFT 538.

The cloud stack 502 is communicatively connected to the client stack 504 over a network 540 such as the internet. The client stack 504 includes a common experience framework layer 542 and a framework service manager layer 544. The common experience framework layer 542 includes a framework loader 546 to load the framework for a session, a user positioning manager 548 to monitor and track the relative position of the user engaged with the session, and a welcome manager 550 to orient the user at the beginning of the session.

The framework service manager layer 544 includes a session manager 552 to manage the session experienced by a user wearing the HMD device 506. The framework service manager layer 544 also includes a secure data manager 554 to store or anonymize any sensitive data, session load manager 556 for loading a session, and a navigation manager 558 for navigating a user through mixed reality scenes of a message management program. The platform 500 is merely illustrative to aid the reader in understanding an embodiment. Other embodiments may include fewer or additional layers/components known to persons skilled in the art but omitted for brevity.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium storing instructions that, when executed by at least one data processor of a smartphone, cause the smartphone to:
cause display of a home screen on a display of the smartphone,
wherein the home screen includes multiple icons presented at locations on the home screen,
wherein each icon is linked to a respective app or widget accessible at the smartphone via the icon, and
wherein the locations are non-overlapping on each page of one or more pages on the home screen;
cause display of a search field on the home screen on the display of the smartphone;
receive user input at the search field including a search query indicative of an app or widget accessible at the smartphone;
identify a particular app or widget that satisfies the search query, a particular icon that is a shortcut to the particular app or widget, and a particular location of the particular icon on the home screen; and
cause display of a visual indication of the particular location of the particular icon on the home screen of the smartphone.

2. The non-transitory, computer-readable storage medium of claim 1, wherein to cause display of the visual indication comprises causing the smartphone to:
display an indication of a path to the particular location of the particular icon on the home screen.

3. The non-transitory, computer-readable storage medium of claim 1, wherein to cause display of the visual indication comprises causing the smartphone to:
display instructions for navigating from a current page of the home screen to the particular location of the particular icon on the home screen,
wherein the particular location is on a page of the home screen other than a current page and the particular location is inside a folder including another icon for another app or widget.

4. The non-transitory, computer-readable storage medium of claim 1, wherein to cause display of the visual indication comprises causing the smartphone to:
display a highlighted version of or movement of the particular icon or a folder on the home screen in which the particular icon is located,
wherein the highlighted version or material distinguishes the particular icon or the folder from other icons or folders on the home screen,
wherein the change includes a glowing effect, an enlarged size or font, a color change, or display of an arrow pointing to the particular icon or the folder, and
wherein the movement includes a back and forth motion, a pulsing motion, or an oscillation of the particular icon.

5. The non-transitory, computer-readable storage medium of claim 1, wherein the smartphone is caused to:
disambiguate the search query for an app or widget that best matches the disambiguated search query,
wherein disambiguation includes correction of misspellings or typographical errors.

6. The non-transitory, computer-readable storage medium of claim 1, wherein the smartphone is caused to:
match a combination of characters in the search query with a name of the particular app or widget.

7. The non-transitory, computer-readable storage medium of claim 1, wherein the smartphone is further caused to:
cause display of the search field overlaid on the home screen of the smartphone including the multiple icons.

8. The non-transitory, computer-readable storage medium of claim 1, wherein the smartphone is further caused to:
cause display of the search field on the home screen of the smartphone,
wherein using the search field maintains simultaneous viewability of the multiple icons on the home screen of the smartphone.

9. The non-transitory, computer-readable storage medium of claim 1, wherein the smartphone is further caused to:
automatically navigate from a current view of the home screen to the particular location of the particular icon of the particular app or widget.

10. The non-transitory, computer-readable storage medium of claim 1, wherein to cause display of the visual indication of the particular location of the particular icon on the home screen comprises causing the smartphone to:
highlight a particular page of the multiple pages other than a current page of the home screen of the smartphone,
wherein the particular page includes the particular icon of the particular app or widget.

11. The non-transitory, computer-readable storage medium of claim 1, wherein to cause display of the visual indication of the particular location of the particular icon on the home screen comprises causing the smartphone to:
highlight a folder icon that contains a subset of the multiple icons including the particular icon of the particular app or widget.

12. The non-transitory, computer-readable storage medium of claim 1, wherein to cause display of the visual indication of the particular location of the particular icon on the home screen comprises causing the smartphone to:
cause the home screen to display the particular icon prominently relative to all other icons displayed on a current page of the home screen.

13. The non-transitory, computer-readable storage medium of claim 1, wherein to cause display of the visual indication of the particular location of the particular icon on the home screen comprises causing the smartphone to:
cause the particular icon or a folder icon including the particular icon to visually oscillate on the home screen of the smartphone.

14. A method comprising:
causing display of multiple icons for respective apps or widgets on a home screen of a user device,
wherein the multiple icons are visual elements with spatial locations on the home screen of a user device,
wherein the spatial locations are configurable by a user of the user device,
wherein each icon is linked to a particular app or widget stored at the user device, and
wherein the spatial location of each icon includes a particular page of multiple pages of the home screen and a particular folder on the home screen storing the particular icon;
receiving user input that includes a search query for a first app or widget stored at the user device,
wherein a result of the search query matches to the first app or widget and maps the result to a first icon linked to the first app or widget; and
causing display of a visual indication that maps to a spatial location of the first icon on the home screen on the user device.

15. The method of claim 14 further comprising, prior to causing display of the visual indication:
matching a combination of characters included in the search query to a name or metadata of the first app or widget,
wherein the match of the combination of characters with metadata accounts for misspellings and typographical errors in the search query.

16. The method of claim 14 further comprising, prior to causing display of the visual indication:
causing display of a search field overlaid on one or more icons on the home screen of the user device,
wherein the search query is input to the search field.

17. The method of claim 16 further comprising:
causing display of a search field on the home screen of the user device,
receive a user input to activate a mode configuring the search field to search for spatial locations of icons on the home screen of the user device,
wherein the search query is input to the search field, and
wherein using the search field maintains simultaneous viewability icons displayed on the home screen of the user device.

18. The method of claim 14, wherein causing display of the visual indication comprises:
displaying navigable instructions from a current view of the home screen to the spatial location of the first icon on the home screen,
wherein the spatial location is on a page of the home screen other than a current page and inside a folder including another icon for another app or widget.

19. The method of claim 14, wherein causing display of the visual indication comprises:
causing the home screen to display the first icon prominently relative to all other icons displayed on a current page of the home screen.

20. The method of claim 14, wherein causing display of the visual indication of the spatial location of the first icon on the home screen comprises:
highlighting a first page of the multiple pages other than a current page of the home screen of the user device,
wherein the first page includes the first icon of the first app or widget; and
highlighting a folder that contains a subset of the multiple icons including the first icon of the first app or widget.

21. The method of claim 14, wherein causing display of the visual indication of the spatial location of the first icon on the home screen comprises:
presenting a first page of the multiple pages overlaying a portion of a current page of the home screen,
wherein the first page includes the first icon of the first app or widget.

22. The method of claim 14, wherein causing display of the visual indication of the spatial location of the first icon on the home screen comprises:
automatically switching display from a current page to another page of the home screen that includes the first icon of the first app or widget.

23. The method of claim 14, wherein the search query is a first search query, the method further comprising:
capturing a verbal command as input from the user to the user device, the verbal command including a second search query for a second app or widget stored at the user device;
wherein a result of the second search query includes an audio indication of the location of the second app or widget and maps on the home screen.
